(19) United States
(12) Patent Application Publication
(10) Pub. No.: US 2013/0238408 A1
(43) Pub. Date: Sep. 12, 2013

(54) SYSTEMS AND METHODS FOR ATTACHING LOYALTY PROGRAM DATA TO AN ELECTRONIC PAYMENT SCHEME

(71) Applicants: Alan COOKE, Dublin (IE); Claire BYRNE, Dublin (IE); Elaine CLARKE, Dublin (IE); Sinead FITZGERALD, Kildare (IE)

(72) Inventors: Alan COOKE, Dublin (IE); Claire BYRNE, Dublin (IE); Elaine CLARKE, Dublin (IE); Sinead FITZGERALD, Kildare (IE)

(73) Assignee: MASTERCARD INTERNATIONAL INCORPORATED, Purchase, NY (US)

(21) Appl. No.: 13/415,207

(22) Filed: Mar. 8, 2012

(51) Int. Cl. G06Q 30/02; G06Q 30/06

(52) U.S. Cl. 705/14.3; 705/14.27; 705/14.33

(57) ABSTRACT

Methods and apparatus are disclosed for attaching loyalty program data to an electronic payment in a payment processing network. In an embodiment, a method transmits, from a merchant to a bank network (BankNet), an authorization request comprising a primary account number (PAN) of a customer and routes the request to a payment card issuer. The method then identifies a loyalty program associated with the PAN and receives, at the BankNet, an authorization response comprising an indicator of the loyalty program. The method forwards the authorization response to an acquirer and sends the authorization response to the merchant. In another embodiment, a system transmits an authorization request and routes the authorization request to a BankNet in response to determining that a merchant is a member of a loyalty program. The system receives an authorization response comprising an indicator of the loyalty program, forwards the response to an acquirer and the merchant.

### FIELD OF THE DISCLOSURE

The present disclosure is directed to a method and apparatus (collectively a system) of attaching loyalty program data to electronic payments using in part a financial transaction card processing system or network as a part thereof.

### DESCRIPTION OF RELATED ART

The increased popularity of loyalty programs in marketing generally and in retailing more specifically has resulted in a proliferation of loyalty programs. Loyalty programs serve two purposes: they provide discounts and rebates to loyalty cardholders (participants) based on the frequency and volume of spending; and they can provide detailed demographic information about consumer spending at the retailer providing the loyalty card program.

Traditional loyalty programs use rewards cards, points cards, advantage cards, or club cards, wherein the cards can be plastic or paper cards, some of which are visually similar to a credit card or debit card. Loyalty cards identify the card holder as a member in a loyalty program. Loyalty cards are a system of the loyalty business model and are referred to as loyalty cards, rewards cards, points cards, discount cards, or club cards, for example. Loyalty cards typically have a barcode or magnetic stripe that can be easily scanned, and some are chip cards. Small key ring cards (or key tags) which serve as key fobs are often used for convenience in carrying and ease of access.

By presenting the card, the purchaser is typically entitled to either a discount on the current purchase, or an allotment of points that can be used for future purchases. Hence, the card is the visible means of implementing a type of what economists call a two-part transaction.

With loyalty programs, there may be agreements by a merchant concerning customer privacy, typically non-disclosure (by the merchant) of non-aggregated data or personally identifiable information (PII) about the customers using the loyalty cards. The merchant, which can be a brick and mortar or online store, uses aggregate data internally (and sometimes externally) as part of its marketing research. These cards can be used to determine, for example, a given customer's favorite brands, or other buying preferences.

When a customer has provided sufficient identifying information, the loyalty card may also be used to access such information to expedite verification during receipt of payment, dispensing of products such as medical prescriptions, or for other membership privileges (e.g., access to a club lounge in airports, using a frequent flyer card, etc.).

Another shortcoming of traditional loyalty programs is that they are dependent on the presentation of a physical loyalty card when completing a purchase. As a result, they depend on the vigilance and consistency of use by a participant/customer. This adversely affects both the retailer and the customer. The retailer's model of consumption is based on associating a loyalty card with a given purchase. Thus, if the consumer does not present the physical loyalty card at the time of the time of the transaction, the purchase data cannot be associated to the card. For the consumer, the discount, points, miles or rewards are not earned for the purchase made without the loyalty card. For merchants, the intended loyalty inducement to purchase certain items (i.e., through discounts) or to reach certain spending levels in order to earn rewards or points is negated when their customers do not have their loyalty cards.

Accordingly, what is needed are systems and methods for attaching loyalty program data to an electronic payment scheme without requiring presentation of a physical loyalty card, keyfob or keytag.

### SUMMARY

Methods and systems are disclosed for attaching loyalty program data to an electronic payment scheme by providing a technical solution utilizing modified but largely existing payment systems such as provided by MasterCard®, which are largely designed to authorize, clear and settle a transaction.

According to an embodiment, an Internet based service provides a consumer the ability to associate card numbers with one or more loyalty programs of which the consumer is a member or participant. For example, a customer can self register his or her credit card (i.e., payment card) details and the associated loyalty schemes of supporting retailers. Once the details have been successfully registered, the consumer is no longer obliged to carry a physical loyalty card or to provide loyalty program data and instead the consumer can now use their linked payment card.

In an embodiment, during the authorization process for a transaction, a retailer's Point-of-Sale (POS) system inquires (e.g., electronically) a financial system to determine if an associated primary account number (PAN) of the consumer has a loyalty program account associated with it. The loyalty program account can then be ‘attached’ to the purchase without requiring the customer to produce a physical loyalty card.

In an alternative embodiment, a communication flow includes embedding loyalty card data as part of standard transaction messages by appending loyalty card data such as the loyalty program account number within the body of standard authorization request data.

In accordance with embodiments, authorization response data sent back via a payment processing system includes loyalty program data for the customer so that a merchant can apply any discounts and the customer can accrue points or miles towards loyalty program rewards for qualified purchases.

The methods and systems described herein use an integral approach from the issuer, loyalty program, and acquirer sides. In one embodiment, an Internet based service provides a consumer the ability to associate one or more card numbers with loyalty schemes. In accordance with an embodiment, the card numbers can be PANs. According to this embodiment, a customer who is a loyalty program member/participant can self register his or her card details and the associated loyalty schemes of supporting retailers. Once the details have been successfully registered, the customer is no longer obliged to use his or her loyalty card. The consumer can now use his or her payment card, whose corresponding PAN has been linked to one or more loyalty programs via the self registration, as part of a transaction and have the registered loyalty card associated with the transaction.

In one embodiment, during the authorization process, the retailer's Point-of-Sale (POS) system communicates (e.g., electronically) with a payment card's Internet service (such as, but not limited to, the MasterCard Internet service) to determine if the associated PAN has an attached loyalty program account. The loyalty program account can then be attached to the purchase without requiring the customer to produce his or her loyalty card.

According to an embodiment, a total amount (purchase amount minus any loyalty program discounts) can be entered at a merchant's point-of-sale (POS) either manually or automatically so that a consumer would see a ticket or receipt for the total amount of goods and services purchased at the merchant, which may be helpful when calculating suggested gratuities and taxes. According to this post-settlement embodiment, a single transaction at a POS can help track use of the payment card, the loyalty account and the individual's interests, purchase profile and demographics.

An exemplary advantage of this approach is that a consumer can associate his or her loyalty account with a given PAN and not have to produce his or her loyalty card at the time of a transaction. Another advantage is that application of loyalty program discounts, rewards and point/mile accruals can be handled through other systems, such as bill payment programs, programs that allow a consumer to control how a payment number can be used (e.g., Purchase Control™ Bill Pay™).

In yet another embodiment, a loyalty service is employed to look up a loyalty account number for a given PAN so that loyalty discounts and point/mile accruals associated with designated purchases are credited to the customer. According to this embodiment, a PAN is used to attach loyalty program data to an electronic payment for a purchase. In accordance with this embodiment, a reward services platform, such as, but not limited to the MasterCard Rewards Services (MRS), can be used attach loyalty program data. Such a loyalty or rewards system can combine features of MRS with MasterCard's InControl™ authorization system to apply discounts to qualified purchases made by loyalty program participants. Similarly, linking a PAN to one or more loyalty program accounts enables a customer to accrue loyalty program points or miles for qualified purchases at merchants without requiring the customer to present a physical loyalty card in order to scan or enter loyalty program data. This embodiment incorporates MRS card registration, thus expanding options for mapping multiple loyalty programs to multiple PANs (i.e., a many-to-many mapping of loyalty cards/accounts to PANs).

### BRIEF DESCRIPTION OF THE DRAWINGS

FIG. 1 illustrates an exemplary financial processing operating environment with different interacting parts of a service for carrying out the presently disclosed system.

FIGS. 2 and 3 are data flow diagrams overlaid on computer architecture diagrams.

FIG. 4 is a block diagram of a system for attaching loyalty program data to an electronic payment scheme, according to an exemplary embodiment of the present disclosure.

FIG. 5 is a message sequence chart of a high level call flow for a method of attaching loyalty program data to an electronic payment scheme, in accordance with an embodiment of the present disclosure.

FIG. 6 depicts use of a database to map multiple primary account numbers (PANs) to multiple loyalty program accounts, according to an embodiment of the disclosed system.

FIG. 7 is a diagram of an exemplary computer system in which embodiments of the present disclosure can be implemented.

The features and advantages of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements. Generally, the drawing in which an element first appears is indicated by the leftmost digit(s) in the corresponding reference number.

### DETAILED DESCRIPTION

As used herein, “credit card number,” “credit card” and “payment card” are sometimes used interchangeably with “financial transaction card number.” These terms mean a credit card, debit card, pre-paid card, hybrid card, payment account number, plastic or virtual card number (VCN), or nearly any other account number that facilitates a financial transaction using a transaction clearance system. VCNs and pre-paid card numbers and other financial transaction card number that can be generally viewed as being more readily issued and disposed of because they do not require the establishment of a line of credit, and can be linked to various controls (amounts, cumulative amounts, duration, controls on spending by amounts, cumulative amounts, types of merchants, geographic controls, to name a few). As used herein, these types of cards (VCN, pre-paid, etc.) are referred to as intelligent transaction card (ITC) numbers. A “loyalty program discount” is an amount deducted from a consumer purchase at a merchant based on a loyalty program offer, or a discount being redeemed by the consumer at the merchant. In addition, a “loyalty program discount” can include points or other credits which the consumer can accumulate and redeem at a later time, or other rebates or offers which the consumer can redeem.

As used herein, the term “loyalty card” is sometimes used interchangeably with a loyalty program account number and means a loyalty program card, the account number for a loyalty program member, or any identifier that can be used to link a loyalty program account to a transaction. For example, in cases where a loyalty program member without a physical loyalty card is prompted by a merchant or POS terminal to scan a barcode or magnetic stripe from a physical loyalty card, loyalty programs may allow the customer to enter an alternate identifier, such as a phone number linked to the loyalty program account, in order to ensure that the loyalty program member receives applicable loyalty program discounts and/or points for purchases.

It is also noted that, as used herein, the terms “customer”, “consumer”, “cardholder”, “card user”, “loyalty program participant”, “loyalty program member”, and “card recipient” can be used interchangeably and can include any user making purchases of goods and/or services. Unless specifically stated differently, in an embodiment, a user is interchangeably used herein to identify a human customer, a software application that converts a general purpose computer to a specific purpose computer, or a group of customers and/or software applications compiled on a computer executed by one or more consumers to conduct a transaction. Besides a human customer who can enroll in a loyalty program, a software application can be used to process purchases. Accordingly, unless specifically stated, the terms “customer”, “consumer”, “cardholder”, “card user”, “loyalty program participant”, “loyalty program member”, and “card recipient” as used herein include specifically programmed computer hardware, and in certain instances can include human beings.

Further, as used herein, the term “issuer” can include, for example, a financial institution (e.g., bank) issuing a card, a merchant issuing a merchant specific card, a stand-in processor configured to act on-behalf of the card-issuer, or any other suitable institution configured to issue a financial card. Finally, as used herein, the term “transaction acquirer” can include, for example, a merchant, a merchant terminal, a point-of-sale (POS) terminal at a merchant, or any other suitable institution or device configured to initiate a financial transaction per the request of a customer.

Examples of systems and methods for routing electronic transactions through financial processing systems (e.g., debit/credit networks) as a part of an electronic payment system are described for example in U.S. application Ser. No. 13/078,374, entitled “Method for Performing Acquirer Routing and Priority Routing of Transactions,” filed on Apr. 1, 2011, which is incorporated herein by reference in its entirety.

### I. Structural Embodiments

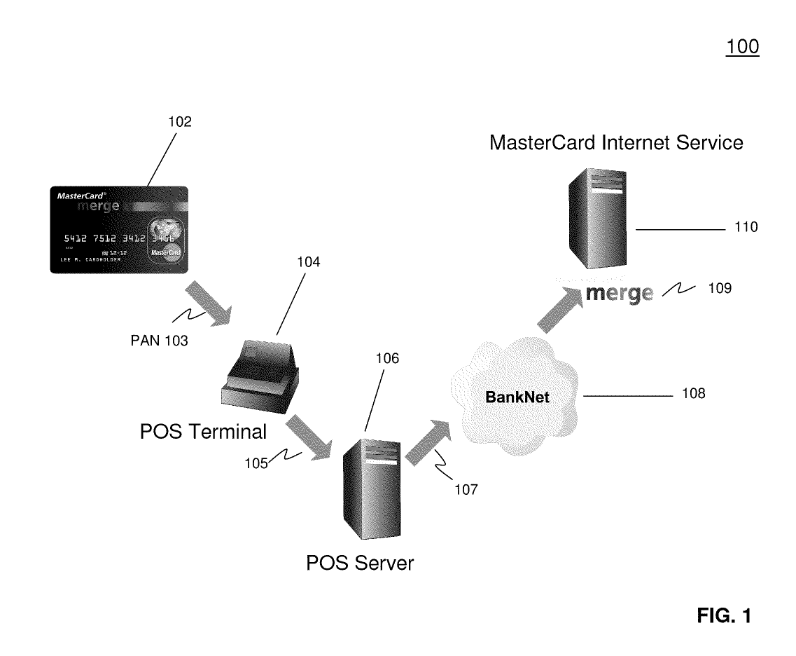

FIG. 1 is a block diagram of an exemplary operating environment 100 for a system for attaching loyalty program data to an electronic payment in a payment processing network, according to exemplary embodiments of the present disclosure. As implemented in the presently described exemplary embodiment, the operating environment 100 depicted in FIG. 1 includes a consumer credit card (i.e., payment card) 102, a point of sale (POS) terminal 104, a POS server 106, a bank network (e.g., MasterCard's BankNet) 108 that facilitates the routing of payment card transactions for authorization, and a payment card Internet service 110 (e.g., MasterCard's Internet Service). As will be appreciated by those skilled in the relevant art(s), while exemplary payment card 102 is depicted as a MasterCard credit card, as noted above, payment card 102 can be embodied as a credit card, debit card, pre-paid card, hybrid card, plastic or virtual card number (VCN), or any other account number that facilitates a financial transaction with POS terminal 104.

With reference to FIG. 1, payment card Internet services 110, such as the exemplary MasterCard Internet Service depicted in operating environment 100, provide various services and product offerings to support customers and vendors. One such product offering, InControl™, allows a cardholder of payment card 102 to set custom controls on usage of their credit, debit and prepaid cards, and even block transactions that they deem inappropriate. Additionally, payment card Internet services 110 enables consumers to receive real-time alerts about card activity via e-mail, text message, or other notification techniques. As a result, they can manage their participation in loyalty programs more efficiently and spend with greater confidence that they are taking advantage of loyalty program rewards, discounts and offers. This is accomplished by using virtual card numbers (VCNs) that are formatted and are processed the same as regular credit and debit card numbers by merchants and acquirers, but at the issuer or at the card processor (e.g., MasterCard), the VCN is mapped in a database to the regular card number for normal authorization checks, and also to controls that are in addition to the normal authorization checks that can be set by the card holder, such as spend limits (both maximum amount per transaction and over a time period), limits on types of merchants or a single merchant, geographic location based controls, etc. See, U.S. Pat. No. 6,315,193; U.S. Pat. No. 6,793,131; U.S. application Ser. No. 10/914,766, filed on Aug. 9, 2004; U.S. application Ser. No. 11/560,212, filed on Nov. 15, 2006; U.S. application Ser. No. 12/219,952, filed on Jul. 30, 2008; and International Application No. PCT/US2009/005029, filed on Sep. 19, 2009, U.S. Published Patent Application No. 2009/0037333, filed on Jul. 30, 2008, all incorporated herein by reference in their entirety (herein the controlled payment numbers or CPN Patents). One example of a VCN is a P-card™ or Purchase card, which can have limits set by a supervising entity and used by another (e.g., a supervisor sets limits on the P-card given to an employee).

Payment card Internet service 110, financial transaction card processors, networks, and issuers also offer prepaid card processing so that payment card 102 can be embodied as a prepaid or ‘gift’ card.

The communication links depicted in operating environment 100 between the various components can be through public and/or private networks or virtual private networks (e.g., the Internet particularly with respect to communications with the cardholder of payment card 102, and private networks such as bank network 108 for others).

As shown in FIG. 1, a PAN 103 associated with payment card 102 is received at POS terminal 104 when a transaction is initiated by a customer. In an embodiment, POS terminal 104 includes a plug-in so that operating environment 100 can be integrated with existing POS terminals in use by merchants participating in loyalty programs. According to this embodiment, the POS plug-in forwards PAN 103 along with transaction data 105 to POS server 106. POS server 106 then forwards an authorization request 107 to bank network 108. In accordance with an embodiment, authorization request 107 includes PAN 103 and sufficient transaction data 105 (e.g., merchant ID, transaction details, transaction amount, etc.) for the transaction to be authorized and for bank network 108 to lookup a loyalty program account linked to the PAN. Bank network 108 then sends an authorization response 109 to card Internet service 110 that, if applicable, has loyalty program data merged with (e.g., attached or appended to) the response message. For example, if bank network 108 determines that the PAN 103 is associated with a loyalty program, bank network 108 can append (e.g., in a packet header and/or in the payload of a packet(s)) a notification in the authorization response 109 that the PAN 103 is associated with a loyalty program.

### II. Architecture and Data Flows

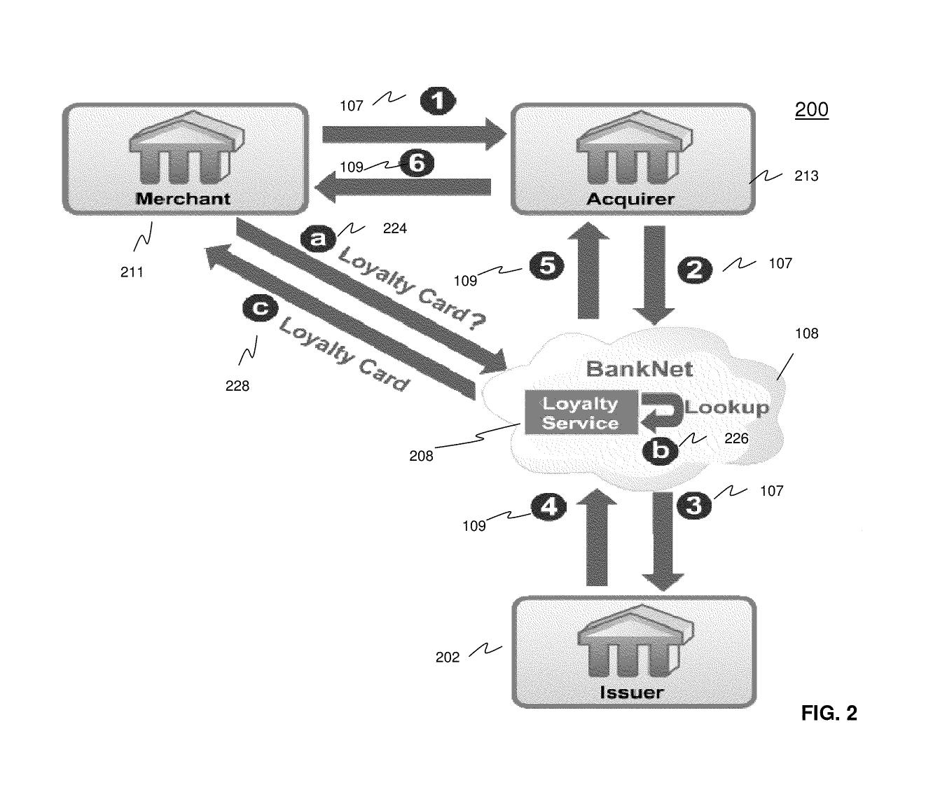

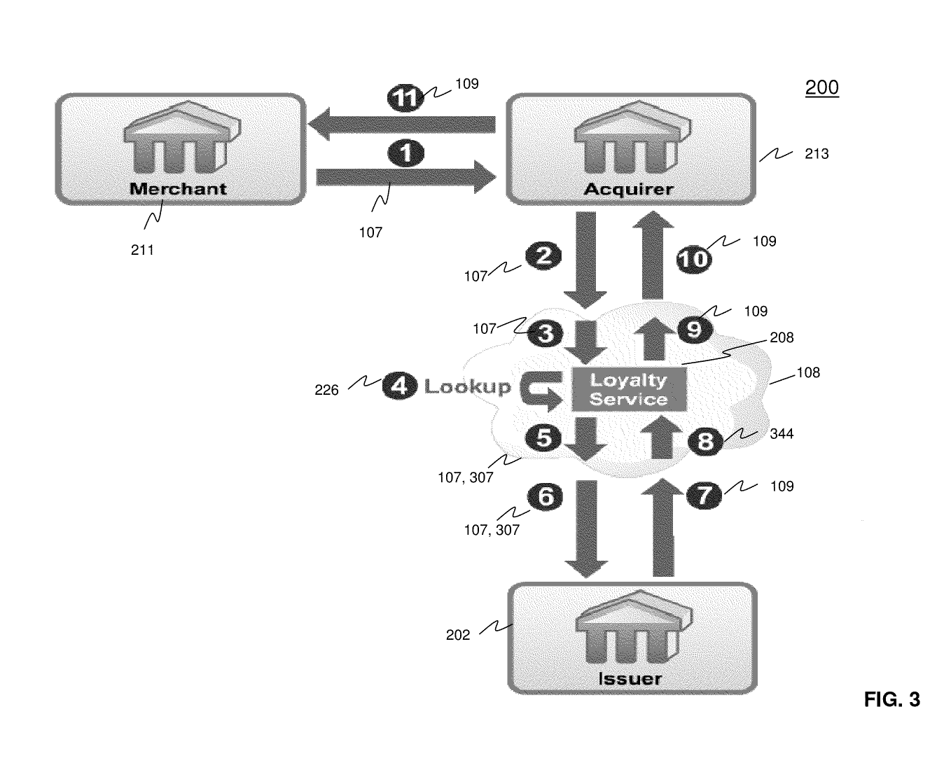

Exemplary architectures for attaching loyalty program data to electronic payments shall now be described with reference to FIGS. 2 and 3.

FIGS. 2 and 3 illustrate exemplary data flows between elements of architecture 200, including depictions of bi-directional communications between the components of the architecture 200 used to attach loyalty program data to electronic payments. FIG. 2 is described with continued reference to the embodiment illustrated in FIG. 1. However, FIG. 2 is not limited to that embodiment.

As shown in FIG. 2, a registered merchant 211 transmits an authorization request 107 to transaction acquirer 213. In an embodiment, merchant 211 has previously registered as a participant in one or more loyalty programs. In one embodiment, merchant 211 administers their own loyalty program. For example, grocery stores, pharmacies, and other merchants 211 can establish and run their own loyalty programs. Merchants 211 can also register to participate in other, external loyalty programs. For example, restaurant, car rental, and lodging merchants 211 can register to participate in one or more airline frequent flyer loyalty programs so that their customers receive points, miles or other credits towards rewards when completing transactions for meals, car rentals, hotel stays and associated services.

If a merchant is participating in a loyalty program, a query 224 for loyalty account information is sent from merchant 211 to bank network 108. In an embodiment, query 224 includes merchant 211 transmitting a PAN 103 associated with payment card 102 to loyalty service 208 hosted by bank network 108. Although loyalty service 208 is depicted as being hosted by bank network 108 in FIGS. 2 and 3, it should be understood that loyalty service 208 can alternatively be external to bank network 108. By way of example and not limitation, in one embodiment, loyalty service 208 can be installed on a computing device associated with issuer 202 (e.g., card Internet service 110).

Asynchronous to query 224, authorization request 107 is received from merchant 211 by acquirer 213 and routed to bank network 108, which in turn sends the authorization request 107 on to the issuer 202. Then, an authorization response 109 is returned to bank network 108.

Asynchronous to the authorization response 109, loyalty service 208 performs a lookup 226 for a loyalty account associated with PAN 103, which in turn is associated with payment card 102. If a loyalty account is found by lookup 226, a query response with identifier 228 for the loyalty account is returned to merchant 211 by bank network 108.

After the authorization response 109 is returned to bank network 108, the authorization response 109 is routed to acquirer 213.

At this point, acquirer 213 sends the authorization response 109 to merchant 211 so that the transaction can be completed. Once the merchant 211 has identifier 228, it can link the purchase transaction to the corresponding loyalty account. As will be apparent to persons skilled in the relevant art, identifier 228 may be a loyalty program account number or an alternative identifier linked to the loyalty account. Examples of alternative identifiers include a customer phone number, personal identification number (PIN), or other alphanumeric identifier linked to the customer's loyalty program account.

In embodiments, as loyalty program query 224, lookup 226 and query response with identifier 228 are carried out asynchronously to a traditional authorization flow of authorization request 107 and corresponding authorization response 109, the loyalty account information can be determined prior to, during, or after processing the payment transaction. Such asynchronous processing enables a customer and a merchant 211 to determine whether a given purchase will be linked to a loyalty program in cases where a purchase transaction has only been initiated, is undergoing processing and has not completed, and post-transaction.

An exemplary data flow embodiment using architecture 200 is also illustrated in FIG. 3. FIG. 3 is described with continued reference to the embodiments illustrated in FIGS. 1 and 2. However, FIG. 3 is not limited to those embodiments.

As shown in FIG. 3, a merchant 211 transmits an authorization request 107, which is then received by an acquirer 213 and routed to a bank network 108.

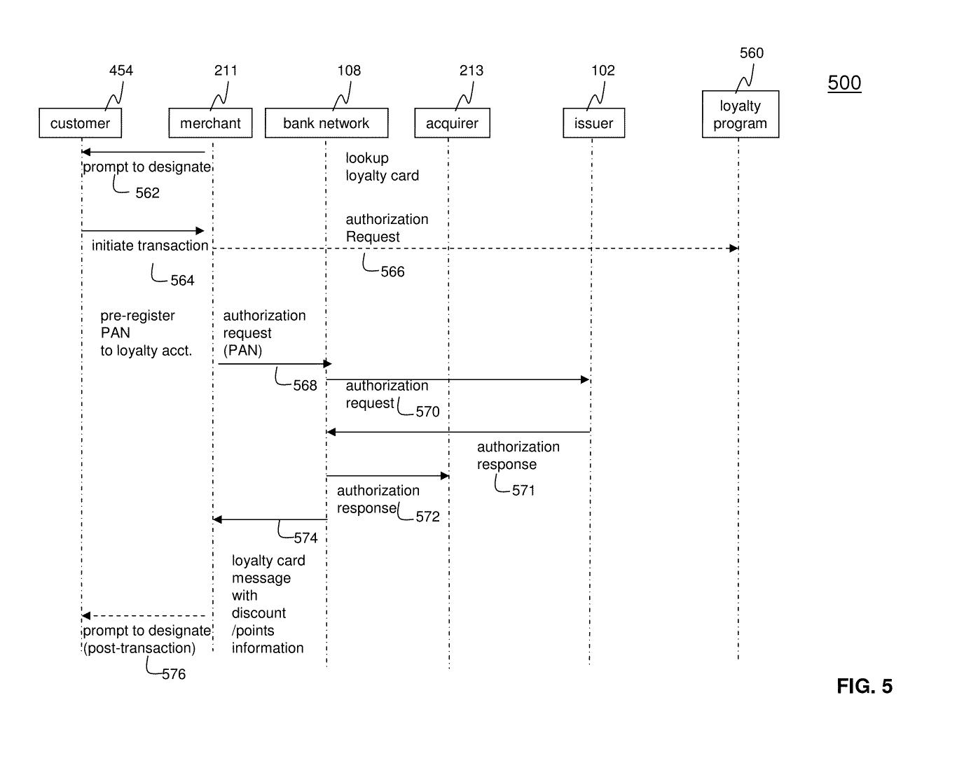

In the embodiment illustrated in FIG. 3, the authorization request 107 arrives at the bank network 108. If a merchant 211 is not a member of a loyalty program, such as loyalty program 560 depicted in FIG. 5, the transaction will be processed in the normal course.

If the merchant 211 is a member of a loyalty program associated with a PAN 103, authorization data from an authorization request 107 is routed via a loyalty service 208 hosted by the bank network 108. At this point, a lookup 226 is performed by the loyalty service 208. The lookup 226 is performed by using card/account details for a payment card 102 contained within the authorization request 107 to lookup loyalty program account details, including a loyalty account identifier 228.

Next, the authorization request 107 is sent on to an issuer 202 by the bank network 108 and upon receiving the authorization request 107, the issuer 202 generates an authorization response 109. The authorization response 109 is returned to the bank network 108 by the issuer 202. As the authorization response 109 is part of a loyalty program, in one embodiment, loyalty card details, such as the identifier 228, are then appended or attached to the authorization response 109 by the loyalty service 208 hosted by the bank network 108. In an alternative embodiment, appending the loyalty card details with at least the identifier 228 is performed by a loyalty service 208 installed elsewhere, such as the issuer 202.

At this point, the authorization response 109 is routed to an acquirer 213 via the bank network 108.

Upon receiving the authorization response 109, the acquirer 213 sends the authorization response 109 to the merchant 211 with the loyalty card data including at least the identifier 228 contained within the response.

With reference to FIGS. 2 and 3, the acquirer 213 communicates with the merchant 211 and the issuer 201 via the bank network 108. Specifically, the architecture 200 can be used by the bank network 108 to receive specific transaction information pertaining to a financial transaction between the merchant 211 and a customer, which is transmitted through the architecture 200 upon initiation of the financial transaction. The architecture 200 can be used to process the transaction by forwarding the transaction information through a particular financial network, such as the bank network 108, and transmitting an authorization request 107 to the issuer 202. The issuer 202 can be, for example, a bank that had issued the payment card 102 which the customer used in the financial transaction. The issuer 202 will then return either an authorization or denial of the financial transaction to the architecture 200 via the bank network 108. Once authorization of the financial transaction is received from issuer 202, and if the transaction information meets predetermined loyalty program criteria, the architecture 200 is configured to transmit loyalty program information via the bank network 108 to the merchant 211.

Another exemplary data flow embodiment using architecture 200 is illustrated in FIG. 3. FIG. 3 is described with continued reference to the embodiments illustrated in FIGS. 1 and 2. However, FIG. 3 is not limited to those embodiments.

This exemplary embodiment advantageously provides a system configuration in which the merchant 211 can conduct a transaction in which a loyalty benefit is applied, if applicable, without the merchant 211 having to deviate from its legacy system of approving payment card transactions, either in a POS transaction or a card-not-present transaction (e.g., an online transaction).

As shown in FIG. 3, the merchant 211 transmits an authorization request 107, which is then received by an acquirer 213 and routed to a bank network 108. The authorization request 107 includes the consumer's PAN 103, an amount of the transaction, and information (e.g., merchant ID) which enables a loyalty service 208 to determine if the consumer's PAN 103 is associated with a loyalty program of which the merchant 211 is a member.

The loyalty service 208, which is hosted by the bank network 108 in this embodiment, performs a lookup 226 to determine if the consumer's PAN 103 is associated with a loyalty program of which the merchant 211 is a member. If the loyalty service 226 determines that the PAN 103 is associated with the merchant's 211 loyalty service, the loyalty service 208 then determines whether the transaction amount contained in an authorization request 107 is to be modified based on the loyalty program. For example, if the value of the transaction is $10.00 and the consumer is to receive a 10% discount under the merchant's loyalty program, loyalty service 208 generates a modified authorization request 307 by replacing the initial authorization request 107 with modified transaction details in accordance with the loyalty program. The modified authorization request 307 includes the consumer's PAN 103 and a transaction ID. The modified authorization request 307 can also include other information such as the merchant ID as well as other authorization information as required by an issuer 202 for approving the transaction based on the instituted authorization controls. Upon generating the modified authorization request 307, the loyalty service 208 stores the transaction ID, for example, in a database of the loyalty service 208, in a record associating the transaction ID with the merchant ID, the modified transaction details, the consumer's PAN 103, and a notification to the merchant of the modification to the transaction based on the consumer's participation or membership in the merchant's loyalty program. The modified transaction details and notification thereof stored in the record are utilized, as will be further described below, in informing the merchant 211 that the consumer's PAN 103 is to be only charged the modified transaction amount because the consumer is participating in or a member of the merchant's loyalty program.

Next, the modified authorization request 307 is forwarded to the issuer 202 by the bank network 108 and upon receiving the authorization request 307, the issuer 202 generates an authorization response 109 on the basis of the modified authorization request 307. In this case, because the modified authorized request 307 contains the modified (e.g., reduced) transaction amount, the issuer 202 authorizes a transaction on the basis of the modified transaction details. Consequently, the issuer 202 does not authorize the transaction on the basis of the initial transaction details, but instead authorizes the transaction on the basis of the modified transaction details contained in the modified authorized transaction request 307. The authorization response 109 is returned to the bank network 108 by the issuer 202.

At this point, the authorization response 109 is routed to an acquirer 213 via the bank network 108. Upon receiving the authorization response 109, the loyalty service 208 recognizes the transaction ID and looks up the stored record corresponding to that transaction ID. Thereafter, the loyalty service 108 appends or attaches, to the authorization response 109, the modified transaction details, the consumer's PAN 103, and a notification to the merchant of the modification to the transaction based on the consumer's participation or membership in the merchant's 211 loyalty program contained in the record associated with the transaction ID. The bank network 108 then routes the authorization response 109 to the acquirer 213.

Upon receiving the authorization response 109, acquirer 213 sends the authorization response 109 to the merchant 211. Upon receiving the authorization response 109, the merchant 211 then concludes the transaction on the basis of the modified transaction details attached or appended to the authorization response 109, since the merchant 211 is apprised of the modification to the transaction due to the consumer's participation in the merchant's 211 loyalty program.

The foregoing example was based on the consumer receiving a discount due to his or her participation in a loyalty program. The present embodiment is not restricted thereto. For instance, if the consumer is to receive another benefit, such as a coupon, rebate or other points or credit, for example, the merchant is informed of such benefits upon receiving the authorization response 109, since the loyalty service 208 appended or attached notification of such benefits when forwarding the authorization response 109 to the acquirer 213, which in turns forwards it to the merchant 211.

Accordingly, in this exemplary embodiment, the merchant 211 does not need to be apprised of the consumer's participation in a particular loyalty program asynchronously while conducting the transaction. On the other hand, the merchant 211 transmits the authorization request 107, and is subsequently notified of any benefit to the consumer under the loyalty program when receiving the authorization response 109.

### III. System Embodiment

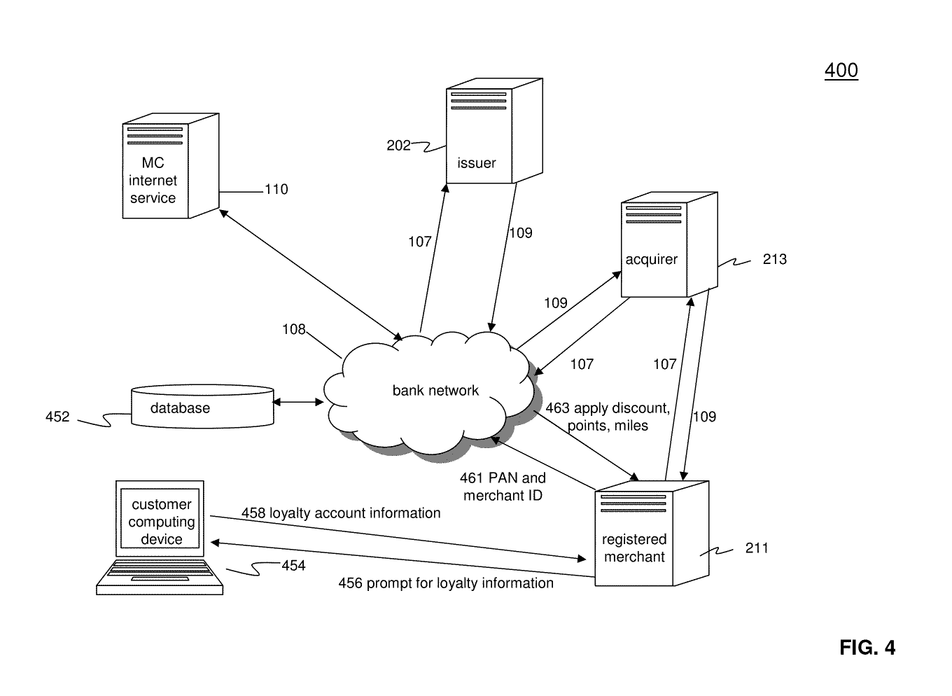

FIG. 4 depicts a system 400 for attaching loyalty program data to an electronic payment scheme, according to an exemplary embodiment. FIG. 4 is described with continued reference to the embodiments illustrated in FIGS. 1-3. However, FIG. 4 is not limited to those embodiments.

The loyalty program information, in some embodiments, can be received via a communication interface device (not shown) by a transaction acquirer 213 and stored within the database 452 of the system 400. In this way, further communication between the system 400 illustrated in FIG. 4 and the loyalty program 560 shown in FIG. 5 could be limited. In other embodiments, the loyalty program offers may not be validated by the loyalty program 560 until a financial transaction occurs thereby triggering communication between the system 400 and the loyalty program 560.

As illustrated in FIG. 4, the system 400 includes a customer computing device 454, a computing device associated with a registered merchant 211, a computing device associated with a transaction acquirer (merchant) 213, a computing device associated an issuer 202, a computing device associated with a payment card Internet service 110, a database 452, and a bank network 108. In one embodiment, the computing device associated with the registered merchant 211 can be a POS server 106.

In the system 400, a customer using a customer computing device 454 engages in a financial transaction with the transaction merchant 211. Such financial transactions can be, for example, POS transactions at a POS terminal 104, or transactions that are performed electronically, such as through the Internet. Types of consumer-merchant transactions that can be used in system 400, as well as the information exchanged between the customer and the registered merchant 211, will be apparent to persons skilled in the relevant art(s).

As described above, a consumer, customer, and loyalty program participant referred to herein can be a natural person, but the customer computing device 454 depicted in FIG. 4 is a computing device associated with a customer, such as, but not limited to, a computer connected via a browser to the Internet. System 400 allows a customer to use any customer computing device 454 to make purchases with a payment card 102, including, but not limited to, a Personal Digital Assistant (PDA), a tablet computing device, an iPhone™, an iPod™, an iPad™, a device operating the Android operating system (OS) from Google Inc., a device running the Microsoft Windows® Mobile OS, a device running the Microsoft Windows® Phone OS, a device running the Symbian OS, a device running the webOS from Hewlett Packard, Inc., a mobile phone, a BlackBerry® device, a smartphone, a hand held computer, a netbook computer, a palmtop computer, a laptop computer, an ultra-mobile PC, a portable gaming system, or another similar type of mobile computing device having a capability to make electronic purchases using a payment card 102.

As shown in FIG. 4, the system 400 sends a prompt 456 for loyalty account information from the merchant 211 to the customer computing device 454, which in turn sends a reply message 458 identifying at least one loyalty program account the customer wishes to attach to a purchase transaction.

The merchant 211 forwards the PAN 103 together with a merchant ID as a message 461 to a bank network 108. As described above with reference to FIGS. 2 and 3, the merchant 211 can then route the authorization request 107 to an acquirer 213, which in turn sends an authorization response 109 back to the bank network 108.

Next, the bank network 108 receives an authorization request 107 from the acquirer 213 and uses the PAN 103 from the message 461 to verify that the loyalty account information provided with the reply 458 to the merchant 211 can be used for the current transaction. In one embodiment, a loyalty service 208 hosted by the bank network 108 may perform this verification via the lookup 226 described above with reference to FIGS. 2 and 3.

Then, the bank network 108 sends the authorization request 107 to an issuer 202, which in turn replies with an authorization response 109 sent back to the bank network 108.

After the bank network 108 receives the authorization response 109, the bank network 108 routes the authorization response 109 to the acquirer 213.

At this point, the acquirer 213 sends the authorization response 109 to the merchant 211 and asynchronously to this flow, the bank network 108 sends a loyalty message 463 instructing the merchant 211 to apply any loyalty program discounts, point accruals, rewards, or other applicable loyalty program benefits to the current transaction.

According to an embodiment, connectivity into the bank network 108 and the loyalty service 208 may be Secure Sockets Layer (SSL) 128 bit encryption supporting the Extensible Markup Language (XML) APIs with server based certificates issued for this service, for example. Collectively, firewall rules would be executed to allow this TCP/IP traffic to flow between the payment card Internet service 110 and POS servers 106 via the Internet by way of a non-limiting example. Additionally, if the loyalty program 560 wants a view into the database 452 via the same APIs they would need to implement similar connectivity rules.

### IV. Method for Attaching Loyalty Program Data to Electronic Payment

An exemplary method for attaching loyalty program data to an electronic payment, such as, but not limited to applying a loyalty discount application, is described below with reference to FIG. 5. FIG. 5 is a block diagram of a high level call flow 500 of a method for attaching loyalty program data to electronic payments, according to embodiments of the present disclosure. FIG. 5 is described with continued reference to the embodiments illustrated in FIGS. 1-4. However, FIG. 5 is not limited to those embodiments.

In step 564, a customer initiates a purchase transaction. For example, a customer might receive a text message, e-mail, or multi-media e-mail that informs him from its content or links to other content of loyalty program offers (e.g., “50% off regular price of a grocery store's house brand for loyalty program participants/members” or “double loyalty points for all purchases this month”).

The communication flow 500 begins at step 562. In step 562, a customer is prompted to designate a loyalty program 560 for a transaction with a merchant 211. This step can include a merchant 211 prompting the customer via an e-mail or text message sent to a customer computing device 454, in an application user interface on a customer computing device 454, or via a message at POS terminal 104. For example, a cashier at a POS terminal 104 can ask the customer if they would like to use one of a plurality of loyalty cards linked to a PAN 103 associated with a payment card 102 being used to purchase qualifying items. Also, for example, the customer computing device 454 can receive a text message, e-mail, or multi-media e-mail prompting for a selection of a loyalty card identifier 228 to use for the current transaction. In an alternative embodiment, this prompt can occur post-transaction as part of step 576.

In step 564, after designating a loyalty card to apply to the transaction, the customer initiates the transaction with the merchant 211.

In step 566, after the merchant 211 receives the request from the customer, the merchant 211 generates an authorization request 107 (566) and forwards it to the loyalty program 560 corresponding to the designated loyalty card. In an embodiment, the authorization request 107 generated in this step need only include transaction information needed by loyalty program 560 in order to determine a discount or loyalty program benefit. For example, in step 566, if the customer designated an airline miles loyalty card identifier 228 in step 562, the airline's loyalty program 560 receives an authorization request 107 indicating the total amount of qualifying purchases in the transaction so that the appropriate number of miles or points are credited for the transaction. Also, for example, in this step, if the merchant 211 is a grocery store with a loyalty program 560 and the customer designated the grocery store's loyalty card in step 562, the grocery store's loyalty program 560 receives an authorization request 107 indicating the total amount of qualifying purchases in the transaction so that the appropriate discounts and/or points are credited for the transaction at the grocery store POS terminal 104.

In addition to sending the authorization request 107 sent in step 566 to the loyalty program 560, the authorization request 107 is sent to the bank network 108 and an issuer 202 in steps 568 and 570, respectively. The authorization request 107 contains information sufficient to process the transaction by each entity.

For example, in step 568, the authorization request 107 sent to the bank network 108 by the merchant 211 includes the customer's PAN 103 and a merchant ID for merchant 211 so that a loyalty service 208 can perform a lookup 226 of the loyalty card identifier 228 for loyalty card linked to the PAN 103. As described above with reference to FIGS. 2-4, the lookup 226 can be a reverse lookup from a database 452 based on the PAN 103 associated with payment card 102.

In step 570, the authorization request 107 is forwarded from the bank network 108 to the issuer 202 and contains sufficient information for the issuer 202 to generate an authorization response 109 for the transaction. For example, the authorization request 107 may include the total amount of the transaction, the geographic location of the merchant 211, the date and time of the transaction so that the issuer 202 can evaluate this data in light of the available credit limit for the account associated with payment card 102 and other controls, such as, but not limited to amounts, cumulative amounts, duration, controls on spending by amounts, cumulative amounts, types of merchants 211 and geographic controls.

In response to receiving the authorization request 107 forwarded in step 570, an authorization response 109 is routed to the acquirer 213 in step 572. As shown in the example embodiment of FIG. 5, the authorization response 109 is routed to the issuer 202 from the acquirer 213. However, as described above with reference to FIGS. 2 and 3, in alternative embodiments, the authorization response 109 can be forwarded to the issuer 202 from the bank network 108.

Depending on the loyalty program offer, discount, or deal, the loyalty program 560 and/or the merchant 211 may have the ability to mass distribute loyalty program offers (not shown). It may also have databases (e.g., the database 452) and processors to distribute the loyalty program offers over the Internet or on paper or other media, for example, through targeted marketing to a plurality of customers with loyalty program accounts who have been determined to qualify for the loyalty program offers. In embodiments, relevant loyalty program promotions and deals are presented to consumers via a website, e-mails or text messages based on previously-received consumer preferences, and transaction history for consumer cards which have been previously-registered with the loyalty program 560.

### V. Alternate Embodiment

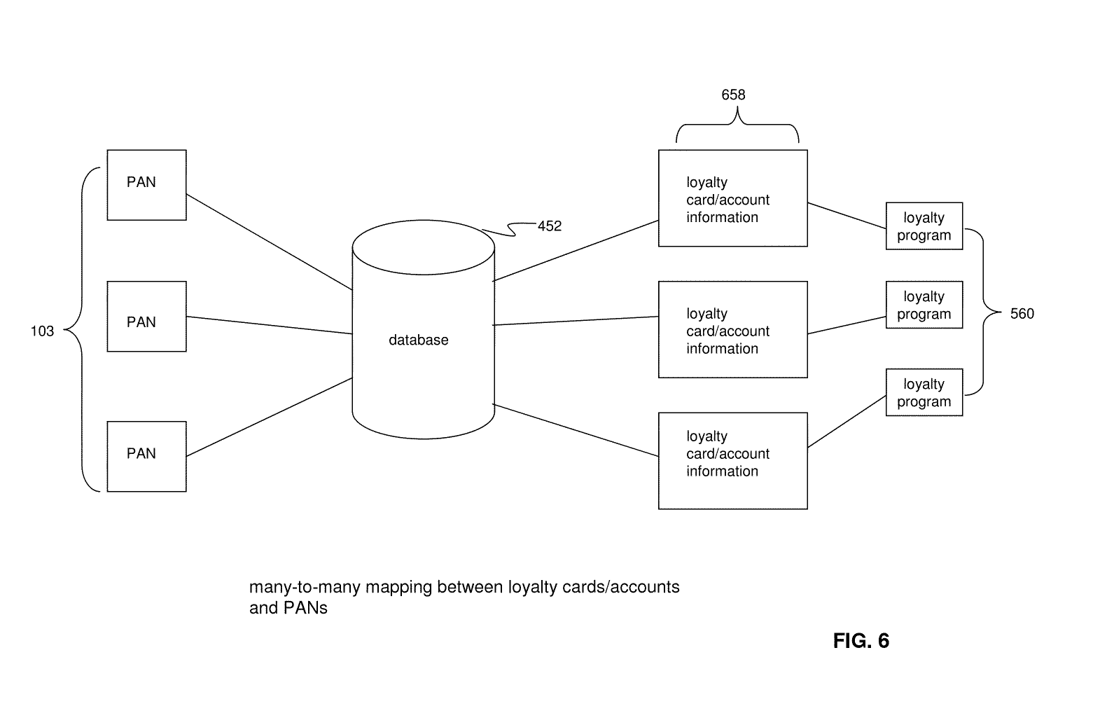

In addition to the data flows described above with reference to FIGS. 2-5, there may be additional components provided as part of the solution. For example, a database 452, such as, but not limited to, a relational database, can be used to map multiple PANs 103 to one or more loyalty accounts by mapping PANs 103 to loyalty card/account 658 (i.e., the many-to-many relationship or mapping shown in FIG. 6). In this way, the database 452 depicted in FIGS. 4 and 6 enables a customer, using an user interface at POS terminal 104 or on a customer computing device 454, to select between a plurality of loyalty programs 560 for a given transaction at a merchant 211. Thus, if a purchase from the merchant 211 can be applied to more than one loyalty programs 560, a customer may choose to map a single PAN 103 to these multiple loyalty programs 560 by linking the PAN 103 to loyalty card/account information 658 corresponding the multiple loyalty programs 560.

For example, if a customer can earn frequent flyer points or miles based on the total amount of a transaction with a merchant 211 and simultaneously qualify for loyalty program discounts from that merchant's own loyalty program 560, mapping one PAN 103 to loyalty card/account information 658 corresponding to multiple loyalty programs 560 in database 452 enables this. Conversely, use of relational mapping in records within the database 452 also enables a customer to accrue loyalty program points or miles towards rewards in a single loyalty program 560 for multiple payment cards 102 associated with multiple PANs 103. Lastly, by establishing a many-to-many mapping between multiple PANs 103 and multiple loyalty programs 560 in the database 452, a customer can get loyalty discounts and earn points for more than one loyalty program 560 while using multiple PANs 103. Enabling such one-to-many and many-to-many mappings may be desirable to customers whose spending patterns with particular merchants 211 qualify for overlapping loyalty program benefits in multiple loyalty programs 560 using a variety of payment cards 102.

### VI. Example Computer System Implementation

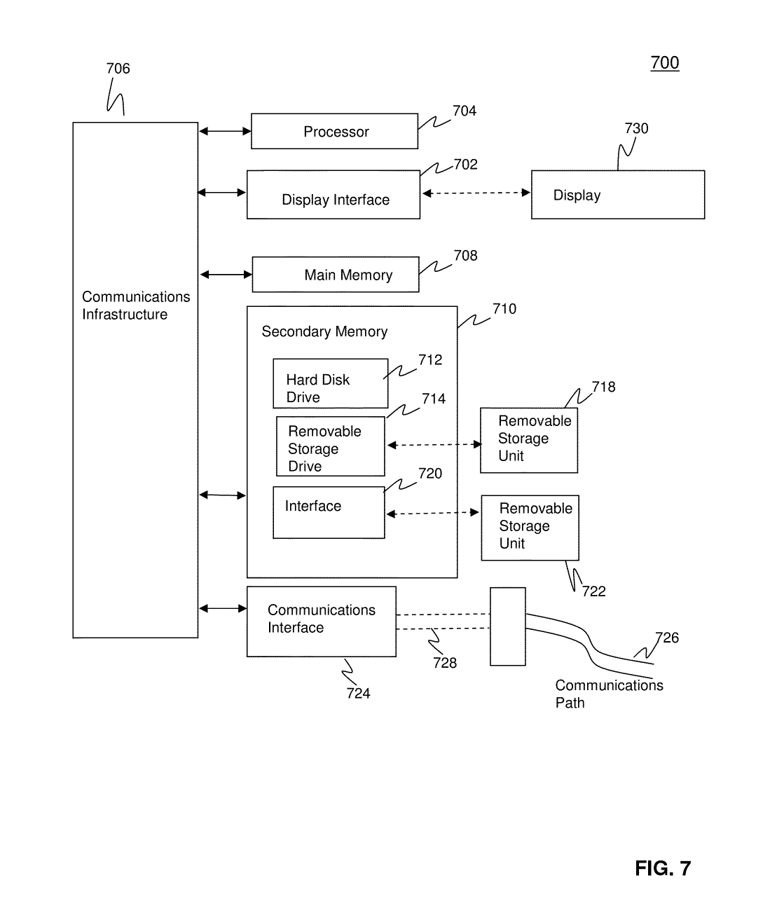

As would be appreciated by someone skilled in the relevant art(s) and described below with reference to FIG. 7, part or all of one or more aspects of the methods and apparatus discussed herein may be distributed as an article of manufacture that itself comprises a computer readable medium having computer readable code means embodied thereon. The computer readable program code means is operable, in conjunction with a computer system, to carry out all or some of the steps to perform the methods or create the apparatuses discussed herein. The computer readable medium may be a recordable medium (e.g., floppy disks, hard drives, compact disks, EEPROMs, or memory cards). Any tangible medium known or developed that can store information suitable for use with a computer system may be used. The computer-readable code means is any mechanism for allowing a computer to read instructions and data, such as magnetic variations on a magnetic media or optical characteristic variations on the surface of a compact disk. The medium can be distributed on multiple physical devices (or over multiple networks). For example, one device could be a physical memory media associated with a terminal and another device could be a physical memory media associated with a processing center.

The computer systems and servers described herein each contain a memory that will configure associated processors to implement the methods, steps, and functions disclosed herein. Such methods, steps, and functions can be carried out, e.g., by processing capability on elements 101 (i.e., a computing device associated with customer), 102, 103, 104, 105 or by any combination of the foregoing. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor.

By way of example, a terminal apparatus associated with each of 101 through 105 could include, inter alia, a communications module, an antenna coupled to the communications module, a memory, and at least one processor coupled to the memory and the communications module and operative to interrogate a contactless payment device (in lieu of the antenna and communications module, appropriate contacts and other elements could be provided to interrogate a contact payment device such as a contact card or read a magnetic stripe). By way of yet a further example, an active file manager apparatus for processing an active file in a payment system, could include a memory, and at least one processor coupled to the memory. The processor can be operative to perform one or more method steps described herein, or otherwise facilitate their performance.

Aspects of the present disclosure shown in FIGS. 1-10, or any part(s) or function(s) thereof, may be implemented using hardware, software modules, firmware, tangible computer readable media having instructions stored thereon, or a combination thereof and may be implemented in one or more computer systems or other processing systems.

FIG. 7 illustrates an example computer system 700 in which embodiments of the present disclosure, or portions thereof, may be implemented as computer-readable code. For example, operating environment 100, architecture 200 of FIGS. 2 and 3, system 400 of FIG. 4 and method 500 of FIG. 5 can be implemented in computer system 700 using hardware, software, firmware, non-transitory computer readable media having instructions stored thereon, or a combination thereof and may be implemented in one or more computer systems or other processing systems. Hardware, software, or any combination of such may embody any of the modules and components used to implement the operating environment, architectures and systems of FIGS. 1-4 and the database of FIG. 6. Similarly, hardware, software, or any combination of such may embody modules and components used to implement the method of FIG. 5.

If programmable logic is used, such logic may execute on a commercially available processing platform or a special purpose device. One of ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device.

For instance, at least one processor device and a memory may be used to implement the above described embodiments. A processor device may be a single processor, a plurality of processors, or combinations thereof. Processor devices may have one or more processor “cores.”

Various embodiments of the present disclosure are described in terms of this example computer system 700. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 704 may be a special purpose or a general purpose processor device. As will be appreciated by persons skilled in the relevant art, processor device 704 may also be a single processor in a multi-core/multiprocessor system, such system operating alone, or in a cluster of computing devices operating in a cluster or server farm. Processor device 704 is connected to a communication infrastructure 706, for example, a bus, message queue, network, or multi-core message-passing scheme.

Computer system 700 also includes a main memory 708, for example, random access memory (RAM), and may also include a secondary memory 710. Secondary memory 710 may include, for example, a hard disk drive 712, removable storage drive 714. Removable storage drive 714 may comprise a floppy disk drive, a magnetic tape drive, an optical disk drive, a flash memory, or the like.

The removable storage drive 714 reads from and/or writes to a removable storage unit 718 in a well-known manner. Removable storage unit 718 may comprise a floppy disk, magnetic tape, optical disk, etc. which is read by and written to by removable storage drive 714. As will be appreciated by persons skilled in the relevant art, removable storage unit 718 includes a non-transitory computer usable storage medium having stored therein computer software and/or data.

In alternative implementations, secondary memory 710 may include other similar means for allowing computer programs or other instructions to be loaded into computer system 700. Such means may include, for example, a removable storage unit 722 and an interface 720. Examples of such means may include a program cartridge and cartridge interface (such as that found in video game devices), a removable memory chip (such as an EPROM, or PROM) and associated socket, and other removable storage units 722 and interfaces 720 which allow software and data to be transferred from the removable storage unit 722 to computer system 700.

Computer system 700 may also include a communications interface 724. Communications interface 724 allows software and data to be transferred between computer system 700 and external devices. Communications interface 724 may include a modem, a network interface (such as an Ethernet card), a communications port, a PCMCIA slot and card, or the like. Software and data transferred via communications interface 724 may be in the form of signals, which may be electronic, electromagnetic, optical, or other signals capable of being received by communications interface 724. These signals may be provided to communications interface 724 via a communications path 726. Communications path 726 carries signals and may be implemented using wire or cable, fiber optics, a phone line, a cellular phone link, an RF link or other communications channels.

In this document, the terms “computer program medium,” “non-transitory computer readable medium,” and “computer usable medium” are used to generally refer to tangible media such as removable storage unit 718, removable storage unit 722, and a hard disk installed in hard disk drive 712. Signals carried over communications path 726 can also embody the logic described herein. Computer program medium and computer usable medium can also refer to memories, such as main memory 708 and secondary memory 710, which can be memory semiconductors (e.g. DRAMs, etc.). These computer program products are means for providing software to computer system 700.

Computer programs (also called computer control logic) are stored in main memory 708 and/or secondary memory 710. Computer programs may also be received via communications interface 724. Such computer programs, when executed, enable computer system 700 to implement the present disclosure as discussed herein. In particular, the computer programs, when executed, enable processor device 704 to implement the processes of the present disclosure, such as the stages in the methods illustrated by FIG. 5, discussed above. Accordingly, such computer programs represent controllers of the computer system 700. Where the present disclosure is implemented using software, the software may be stored in a computer program product and loaded into computer system 700 using removable storage drive 714, interface 720, and hard disk drive 712, or communications interface 724.

Embodiments of the present disclosure also may be directed to computer program products comprising software stored on any computer useable medium. Such software, when executed in one or more data processing device, causes a data processing device(s) to operate as described herein. Embodiments of the present disclosure employ any computer useable or readable medium. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, and optical storage devices, MEMS, nanotechnological storage device, etc.), and communication mediums (e.g., wired and wireless communications networks, local area networks, wide area networks, intranets, etc.).

Accordingly, it will be appreciated that one or more embodiments of the present invention can include a computer program comprising computer program code means adapted to perform one or all of the steps of any methods or claims set forth herein when such program is run on a computer, and that such program may be embodied on a computer readable medium. Further, one or more embodiments of the present invention can include a computer comprising code adapted to cause the computer to carry out one or more steps of methods or claims set forth herein, together with one or more apparatus elements or features as depicted and described herein.

### VII. Conclusion

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A method of attaching loyalty program data to an electronic payment, the method comprising:
receiving an authorization request comprising a primary account number (PAN) of a customer of a merchant;
routing the authorization request to an issuer;
identifying at least one loyalty program associated with the PAN;
receiving an authorization response comprising an indicator of the at least one loyalty program;
forwarding the authorization response to an acquirer; and
sending the authorization response to the merchant.

2. The method of claim 1, wherein receiving the authorization request comprises receiving the authorization request from a merchant at a bank network.

3. The method of claim 3, wherein receiving the authorization response comprises receiving the authorization response at the bank network.

4. The method of claim 1, wherein the transmitting, identifying, and sending are performed asynchronously.

5. The method of claim 1, further comprising applying, at a point-of-sale (POS) terminal at the merchant, a discount associated with the at least one loyalty program.

6. The method of claim 1, wherein the PAN is associated with a customer payment card linked to a loyalty program via a registration at a loyalty program website.

7. The method of claim 6, further comprising prompting the customer to link a PAN with one or more loyalty programs.

8. The method of claim 7, wherein the prompting occurs prior to the transmitting.

9. The method of claim 7, wherein the prompting occurs after the sending.

10. The method of claim 1, wherein a plurality of PANs associated with a plurality of customer payment card accounts are linked to one or more loyalty programs via registration at a respective one or more loyalty program web sites.

11. The method of claim 10, further comprising prompting the customer to select a loyalty program from the one or more loyalty programs to be associated with the electronic payment.

12. The method of claim 1, further comprising, registering, by the merchant, as a participant in the at least one loyalty program.

13. A system for attaching loyalty program data to an electronic payment, the system comprising:
means for receiving an authorization request comprising a primary account number (PAN) of a customer of a merchant;
means for routing authorization request to a bank network in response to determining that the merchant is a member of at least one loyalty program;
means for confirming that the at least one loyalty program is associated with the PAN;
means for routing the authorization request to an issuer;
means for receiving an authorization response comprising an identifier for the at least one loyalty program;
means for forwarding the authorization response to an acquirer; and
means for sending the authorization response to the merchant, wherein the authorization response comprises loyalty program data for the customer.

14. The system of claim 13, wherein the means for transmitting further comprises means for transmitting the authorization request from a merchant to the bank network.

15. The system of claim 14, wherein the means for receiving further comprises means for receiving the authorization response at the bank network.

16. The system of claim 14, wherein the authorization request is routed via a loyalty service.

17. The system of claim 16, wherein the loyalty service is hosted on the bank network.

18. The system of claim 13, wherein:
the response includes a plurality of identifiers for a respective plurality of loyalty programs whose benefits are applicable to the electronic payment; and
the plurality of identifiers are appended to the authorization response.

19. A non-transitory computer readable storage medium having program instructions stored thereon for attaching loyalty program data to an electronic payment, the instructions being executable by a processor of a computing device, the instructions comprising:
instructions for receiving an authorization request from a merchant, the request comprising a primary account number (PAN) of a customer of the merchant;
instructions for routing the authorization request to an issuer;
instructions for identifying at least one loyalty program associated with the PAN;
receiving, at a bank network, an authorization response comprising an indicator of the at least one loyalty program;
instructions for forwarding the authorization response to an acquirer; and
instructions for sending the authorization response to the merchant.

20. The computer readable storage medium of claim 19, wherein the instructions for receiving an authorization request comprise instructions for receiving the authorization request from a merchant at a loyalty service of the bank network.
